(19) United States
(12) Patent Application Publication
(10) Pub. No.: US 2010/0058657 A1
(43) Pub. Date: Mar. 11, 2010

(54) GREEN ROOF EDGING AND RESTRAINT SYSTEM

(76) Inventor: Douglas C. Fishburn, Hornby (CA)

Correspondence Address: BAKER & DANIELS LLP;111 E. WAYNE STREET, SUITE 800, FORT WAYNE, IN, 46802, US

(21) Appl. No.: 12/546,892

(22) Filed: Aug. 25, 2009

(30) Foreign Application Priority Data
Sep. 9, 2008 (CA) 2639422

(51) Int. Cl. A01G 1/08

(52) U.S. Cl. 47/33; 52/102

(57) ABSTRACT

An edging system for green roofing applications defines the margin between grow medium zones and vegetative free zones. An edge and restraint system comprises a edging structure having a substantially upright section having a height and a base section extending laterally from a the middle or lower end of the upright section on at least one lateral side thereof. The base section extends substantially perpendicularly from the upright section. The upright section and base sections may or may not include openings therethrough to allow drainage of water and the like. The upper end of the upright section is adapted to allow a restrainer piece to be releasably secured thereto in snap fit engagement. An edge of a water permeable fabric, which extends between a grow medium and drainage board upon which the grow medium is contained, is essentially secured in place at one end thereof by positioning an end portion thereof which extends from under the grow medium under the restrainer piece as it is snapped in place upon the upright section.

### FIELD OF THE INVENTION

The invention relates to an edging and restraint system for use with green roofing systems. The invention provides a number of functions including to secure drainage boards and filter fabric in place and to separate growing medium and vegetative free zones.

### BACKGROUND OF THE INVENTION

A green roof is a roof of a building that is covered with vegetation and a growing medium (soil), typically planted over a water-permeable fabric to separate the growing medium from the drainage system which is located above waterproofing membrane. The water-preamble fabric may also contribute to keeping the insulation boards in alignment and assisting in the redistribution of wind loads. It may also include additional layers such as a root barrier and irrigation systems. Some roof membranes may provide protection against root penetration.

Green roofs may be constructed from principally two types of roof systems.
1. Protected Roof Membrane, where the insulation is placed above the roof membrane.
2, A Conventional Roof System, where the insulation is placed below the roof membrane. In colder climates a vapour barrier may have to be located below the insulation.
3. In warmer climates where there is no requirement for insulation to conserve energy or forestall condensation, the insulation may be omitted. Green roofs are often referred to as vegetation roofs and in addition to the normal function for providing waterproofing the roof space is utilized to provide gardens. When shallow depths of growing medium are used they are typically referred to as extensive green roofs system because of their shallow depths of soils, lower dead loads and narrow selection of plant varieties.

When the depth of the growing medium increases typically beyond 6″ these roofs are referred to as intensive. Intensive green roofs are categorized by a greater depth of growing medium, higher dead loads and are suitable for a wider variety of plants.

Landscaping over low slope roofs is very unconventional and the design principles must include providing a proper environment for the waterproofing system while providing a proper environment for the plants. Because the plants are elevated and placed on the roof the environment is more extreme since they do not have the availability of large quantities of soil for anchoring roots, ground water and are subject to higher winds and hotter temperatures.

Regardless of the type of green roof system, vegetative free zones are common and are used to separate vegetative areas from flashings, roof openings, etc. Such vegetative free zones are desirable on green roofs for various reasons such as: to allow for pedestrian traffic during construction or maintenance, act as a fire break, allow for drainage away from flashings and venting of moisture from subsurface roof components and allow inspection and maintenance of flashings without disturbing the vegetation. Vegetative free zones are desirable as they resist wind uplift and scouring at the roof perimeter partially at the corner of the roofing system. Ballasts such as gravel or concrete pavers are often used in the vegetative free zones to provide higher wind resistance.

Known edging systems are used at grade level to define margins of hard landscaping such patio stones, concrete blocks, stones where they terminate at lawns, flower beds, pavement, ponds or the like.

In order to provide a termination point between the growing medium and vegetative free zones and to secure a water permeable fabric which sits below the grow medium, an improved edging and restraint system is required which is suitable for green roofing applications taking into account the roof environment.

### SUMMARY OF THE INVENTION

In accordance with an aspect of the invention there is provided an edging system for green roofing applications to define the margin between grow medium zones and vegetative free zones.

The edging restraint system can be used as a restraint system and to keep the Pavers or gravel ballast in line, an important aspect of the invention is to keep the various landscaping components in place, particularly during construction when the roofs construction may be at various stages of completion and subject to more damage from the weather.

The restraint system of the herein invention is designed to allow phase construction of a roof by allowing the vegetative free zones to be completed prior to the placement of the growing medium or plants.

The restraint system of the herein invention is intended to increase the resistance of the drainage panel and water permeable fabric against wind and construction traffic.

In accordance with an aspect of the invention there is provided, an edge and restraint system comprising a edging structure having a substantially upright section having a height and a base section extending laterally from a the middle or lower end of the upright section on at least one lateral side thereof. The base section extends substantially perpendicularly from the upright section. The upright section and base sections may or may not include openings therethrough to allow drainage of water and the like. The upper end of the upright section is adapted to allow a restrainer piece to be releasably secured thereto. In an example of the invention, the restrainer piece is secured in snap fit engagement over the upper end, said upper edge including a flange portion over which the restrainer piece is snap fit. An edge of a water permeable fabric, which extends between a grow medium and drainage board upon which the grow medium is contained, is essentially secured in place at one end thereof by positioning an end portion thereof which extends from under the grow medium under the restrainer piece as it is snapped in place. When the restrainer piece secured upon the top of the upper end of the upright portion, a portion of the restrainer piece extends downwardly toward the base section and extends to cover the end portion of the exposed water permeable fabric so as to secure it in place, provide UV protection and hide it from view.

In a particular advantageous application of the invention, the restraint system may be utilized to create vegetative free zones around the perimeter of the roofing structure and to create wind zones to protect the grow medium portions and against severe wind and other environmental factors most prominent at the roof edges.

Other advantages, features and characteristics of the present invention, as well as methods of operation and functions of the related elements of the structure, and the combination of parts and economies of manufacture, will become apparent upon consideration of the following detailed description and the appended claims with reference to the accompanying drawings, the latter being briefly described hereinafter.

### BRIEF DESCRIPTION OF THE DRAWINGS

FIG. 1 is a section view of an example embodiment of a restraint/edging system in accordance with an aspect of the invention;

FIG. 2 is close up detail view of the embodiment of FIG. 1, taken within circle marked A;

FIG. 3 is a section view of an alternate embodiment of the invention; and

FIG. 4 is a section view of a further alternate embodiment of the invention.

### DETAILED DESCRIPTION OF THE INVENTION

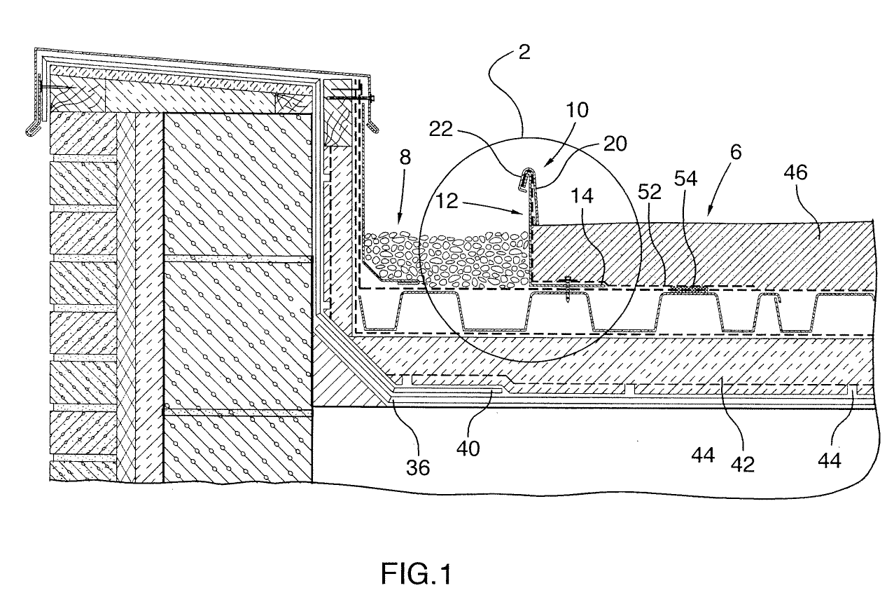

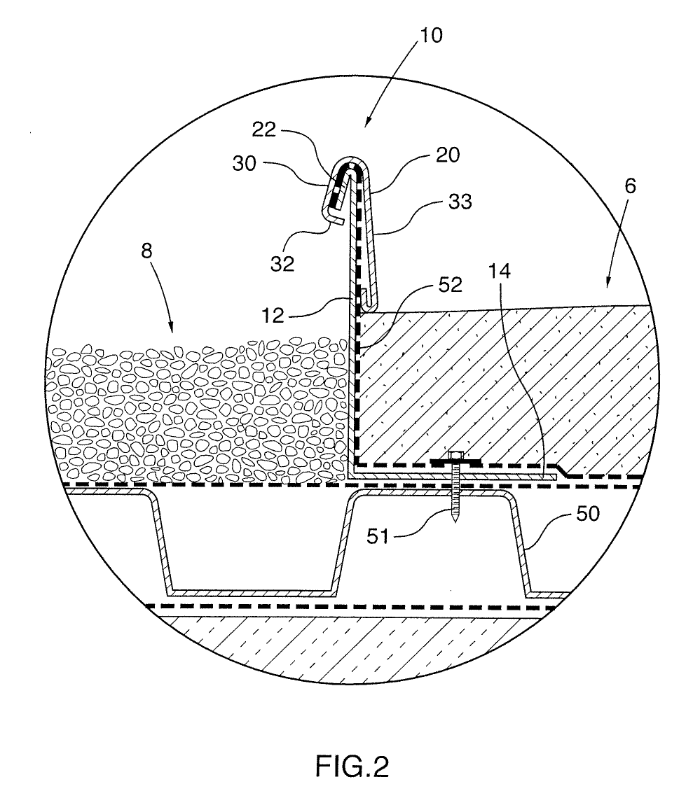

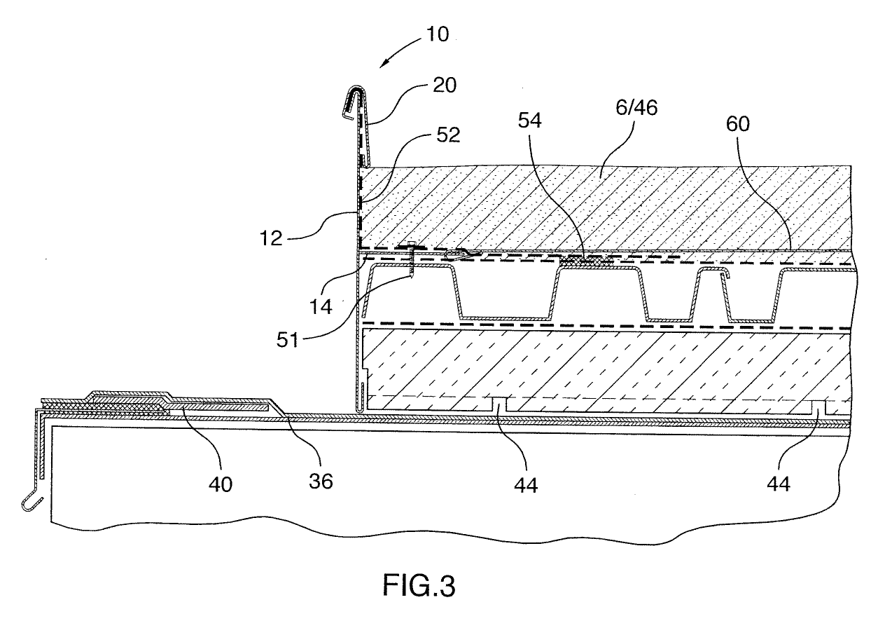

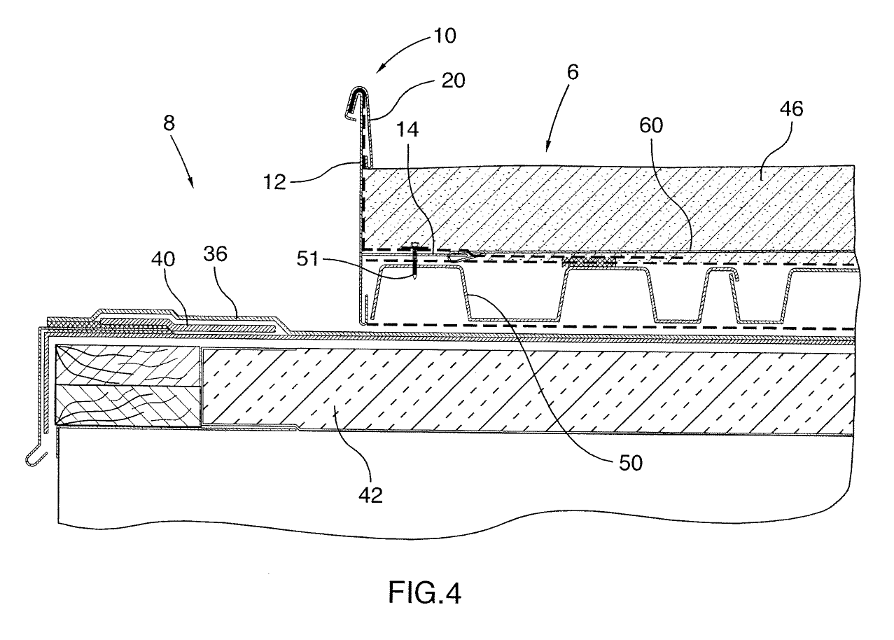

Embodiments of the green roof edging restraint system of the invention are shown in FIGS. 1 to 4. An aspect of the invention is primarily designed for green roof applications in order to define the margins between vegetative grow zones (6) and vegetative free zones (8). It should be understood that at least some of the advantages of the invention may be realized in other setting and applications. The restraint system of the invention comprises an edging and restraint structure (10) having a substantially upright section (12) having a height and a lateral base section (14) extending laterally from a middle (as shown in FIGS. 3 and 4) or lower portion (as shown in FIGS. 1 and 2) of the upright section on at least one lateral side thereof. The base section (14) extends substantially perpendicularly from the upright section. The upright section (12) may or may not include openings (16) therethrough to allow drainage of water and the like. The upper end (18) of the upright section is adapted to allow a restrainer piece (20) to be releasably secured thereto. In the example shown, the restrainer piece is secured in snap fit engagement over the upper end (18), said upper edge including a flange portion (22) over which the restrainer piece is snap fit. In the example embodiment shown, the restrainer piece is formed of resilient material and comprises a first portion (30) having an inwardly facing peripheral lip (32) which is adapted to snap fit over flange portion (22) and a second portion (33) connected to the first portion at the top of the piece (20), extending downwardly along opposite side of the upright section (12) on the opposite side to the flange portion (22). When the restrainer piece (20) is snap fit upon the top of the upper end (18) of the upright portion (12), it extends downwardly over an edge portion of filter fabric (also referred to as water permeable fabric) (52) which sits under the second portion of the retainer piece as it is snap fit into place over the upper end. The second portion (33) extends downwardly toward the base section to a point adjacent to or below the top of the growing medium (46). The retainer piece thus locks the filter fabric in place to resist movement thereof and wind uplift and covers it from plain view.

Embodiments of the invention are shown in use with typical green roof systems in FIGS. 1 to 4. Such green roof systems include a roof membrane (36) upon the roof (38), roof flashings (40), and an insulation layer (42), which may have drainage groove (44) below the grow medium 46). A root barrier (48) is present to prevent intrusion of vegetative roots into the roof. Above the root barrier is a drainage source such as a drainage panel (50) upon which sits a filter fabric layer (also referred to as a water permeable fabric layer) (52). This filter fabric is designed to contain the grow medium, but allow water to flow therethrough. To secure the filter fabric (52) in place on the drainage board or panel (50), the filter fabric may be secured to the drainage board by means of any suitable adhesive or attachment means (54).

In the embodiments shown, the edging restraint structure (10) is securable to the roof, by means of securement of the base section (14) to the drainage board (50) with a mechanical fastening, such as a screw (51) or the like (however it could be secured to any intervening structure or alternate structures desired in alternate green roofing system as desired). Portion (33) of the restrainer piece (20) which is snap fit at the upper edge of the upright section extends downwardly on the at least one lateral side of the structure to the position of the upper edge to the top edge of the growing medium and in addition to the advantages described above provides UV protection for the portion of the filter fabric layer (52) extending above the grow medium.

In the embodiment shown, restrainer piece (20) provides a smooth rounded cap positioned in snap fit over the upper edge of the upright portion so as to reduce the risk of someone cutting themselves on the top of the retainer should someone fall or trip over it. This also adds to its aesthetics appeal.

In accordance with an aspect of the invention the snap on restrainer not only acts as a restraint for the fabric but acts to enforce the strength of the upright section, thereby acting as a joint in the sense of keeping the foot or bottom section in alignment since the joints of the snap on restrainer are offset to the upright portions.

The restrainer piece can be manufactured from metal such as stainless steel or other corrosion resistant materials as to reduce the risk of corrosion from leachate from the growing medium, fertilizer due to its exposure to moisture. When the edging restraint system may be used on a roof with a drip edge or at an opening for draining off water (i.e. scuppers), such as shown in FIG. 3, the base (14) lateral section is positioned at a middle section along the upright portion (12), with a portion of the upright section of the edging restrainer system extended downwardly below the base lateral section, acting to hide the face of the insulation and/or drainage board of the green roof system. FIG. 4 illustrates the positioning of the insulation layer below the flashing and roof membrane.

As can be seen in FIGS. 3 and 4, the restraint system may be secured to the roof and/or building as an example with cables (60) affixed to the restraint structure, shown in FIGS. 3 and 4 attached to the base portion thereof, which will assist to keep the insulation and drainage board in place, such as for example when drip flashings are used, otherwise they could become dislodged particularly when the roof has a steeper slope.

It should be understood that the edging structure of the restrainer system of the invention may be installed in short or long sections. Typically, long sections are used for straight runs on a roof and shorter sections are used at bends or curves. Adjacent edging structures of the restrainer system may be secured in parallel by any suitable means, such as mechanical fastening or the like to form a seamless and continuous margin between the vegetative free zones and grow mediums throughout the entire roof. It should be understood that, the edging structure may be formed in straight sections or if desired to meet the needs of the user, it may be curved to formed curved margins between the vegetative free zones and grow medium.

It should be understood that many changes, modifications, variations and other uses and applications will become apparent to those skilled in the art after considering the specification and the accompanying drawings. Therefore, any and all such changes, modifications, variations and other uses and applications which do not depart from the spirit and the scope of the invention are deemed to be covered by the invention.

1. An edge and restraint system comprising: a edging structure having a substantially upright section having a height and an upper edge section, and a base section extending laterally from a middle or lower end of the upright section on at least one lateral side thereof, the base section extending substantially perpendicularly from the upright section, a restrainer piece is releasably secured over the upper edge section, and an edge of a water permeable fabric, which extends below a grow medium adjacent said edging structure is secured in place at one end thereof by positioning an end portion thereof which extends from under the grow medium under the restrainer piece as it secured in place upon the upper edge section.

2. An edge and restraint system as recited in claim 1 wherein the restrainer piece is releasably secured in snap fit engagement over the upper edge section.

3. An edge and restraint system as recited in claim 1 wherein the upright section and base sections include openings therethrough to allow drainage of water.

4. An edge and restraint system as recited in claim 2 wherein said upper edge portion includes a lateral flange portion over which the restrainer piece is snap fit.

5. An edge and restraint system as recited in claim 4 wherein the restrainer piece is formed of resilient material and comprises a first portion having an inwardly facing peripheral lip which is adapted to snap fit over said lateral flange portion and a second portion connected to the first portion at a top of the piece, extending downwardly along opposite side of the upright section on the opposite side to the lateral flange portion.

6. An edge and restraint system as recited in claim 5 wherein when the restrainer piece is snap fit upon the top of the upper end of the upright portion, it extends downwardly over an edge portion of water permeable fabric which is secured under the second portion of the retainer piece and extends between a grow medium and drainage board upon which the grow medium is contained.

7. An edge and restraint system as recited in claim 5 wherein the second portion extends downwardly toward the base section to a point adjacent to or below the top of a growing medium.

8. An edge and restraint system as recited in claim 6 wherein the edging restraint structure is securable to the roof, by means of securement of the base section to the drainage board.

9. An edge and restraint system as recited in claim 8 wherein the edge restraint structure is secured to the drainage board by mechanical fastening means.

10. An edge and restraint system as recited in claim 1 wherein the restrainer piece provides a smooth rounded cap over the upper edge of the upright portion.

11. An edge and restraint system as recited in claim 1 wherein the restrainer piece comprises stainless steel.

12. An edge and restraint system as recited in claim 1 wherein the restraint system may be secured to the roof and/or building by means of cables attached at one end to the roof and affixed to the base portion at the other end thereof.
